(19) United States
(12) Patent Application Publication
(10) Pub. No.: US 2010/0138813 A1
(43) Pub. Date: Jun. 3, 2010

(54) METHOD AND APPARATUS FOR TESTING ONLINE PERFORMANCE ON CLIENT/SERVER ARCHITECTURE

(75) Inventors: Ju Young KIM, Daejeon (KR); Chang Joon PARK, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/490,032

(22) Filed: Jun. 23, 2009

(30) Foreign Application Priority Data
Dec. 1, 2008 (KR) 10-2008-0120800
Mar. 19, 2009 (KR) 10-2009-0023513

(51) Int. Cl. G06F 9/44; G06F 15/16

(52) U.S. Cl. 717/131; 717/124; 709/204

(57) ABSTRACT

An apparatus for testing online performance on a client/server architecture, includes: a client group connected to a server group; and a server group for providing the online service to the client group and capturing packet information based on communication with the client group. Further, the apparatus for testing online performance on a client/server architecture includes a central management unit for carrying out analysis, edition, and scripting for the captured packet information to overall manage an online performance test between the client group and the server group; and a load generation unit for generating a virtual client in accordance with the scripting result of the central management unit to regenerate a load in the server group.

### CROSS-REFERENCE TO RELATED APPLICATIONS

The present invention claims priority of Korean Patent Application No. 10-2008-0120800, filed on Dec. 1, 2008, and Korean Patent Application No. 10-2009-0023513, filed on Mar. 19, 2009, which is incorporated herein by references.

### FIELD OF THE INVENTION

The present invention relates to a software test technology for an automatic test of a multi-user server application, and more particularly, to a method and apparatus for testing online game performance suitable for a test of performance and stability of an online game server application through load test.

### BACKGROUND OF THE INVENTION

In viewpoint of software engineering, a study on a test for server stability through generation of an arbitrary load and application of the load to a server is a load test. This load test includes a concept of a stress test for observation of abnormality of the server is observed in a high load state.

When a virtual client as a real client is used, or in the case of a Web server, studies on use of a network packet to be captured as a load are in progress. In recent years, in order to execute a test for server stability in a real-like network environment, studies on addition of a structure for a virtual network circuit in a simulation environment are in progress.

In development of a client/server-based online game, a test of stability of an online game server application is important. From this point of view, a technology for testing online performance on the client/server architecture has been continuously developed.

Of these, a technology for regeneration of packets to be collected as a large load has been studied in various ways. In the related art, a method that uses a real game client, and a method that collects communication packets with a game server at a game client end to regenerate a large quantity of packets are used.

The former method is disadvantageous in that many portions are handled on the program, and high-quality skills are needed in the application of a real test. The latter method is prepared for a test of a Web server, thus it is difficult to test an interactive application such as a game.

Even though a technology is produced in consideration of the characteristics of the game, there is a limit to generate play of multiple users by a method, which captures game play packets of a single game user at the game client end and regenerates a large quantity of packets. In addition, it is difficult to reproduce a game play of multiple users as it is.

### SUMMARY OF THE INVENTION

In view of the above, the invention provides a technology for testing online performance on a client/server architecture that collects all game play communication packets between a plurality of game clients and servers, captures packets of all the game clients at the game server end, and reproduces or regenerates a large load, thereby collecting various behavioral patterns of the game users for a test of performance of the server.

Further, the invention provides a technology for testing online performance on a client/server architecture that allows reproduction of game play of the game users to repeat occurrence of a problem in stability of a server, thereby effectively finding a problem in the server to rapidly solve the problem.

In accordance with a first aspect of the present invention, there is provide an apparatus for testing online performance on a client/server architecture, the apparatus including: a client group connected to a server group through a network to use an online service; a server group for providing the online service to the client group through the network and capturing packet information based on communication with the client group; a central management unit for carrying out analysis, edition, and scripting for the captured packet information to overall manage an online performance test between the client group and the server group; and a load generation unit for generating a virtual client in accordance with the scripting result of the central management unit to regenerate a load in the server group.

In accordance with a second aspect of the present invention, there is provide an apparatus for testing online performance on a client/server architecture, the apparatus including: a client group connected to a server group through a network to use an online service; a server group for providing the online service to the client group through the network; a packet capture unit for capturing packet information based on communication between the client group and the server group; a central management unit for carrying out analysis, edition, and scripting for the captured packet information to overall manage an online performance test between the client group and the server group; and a load generation unit for generating a virtual client in accordance with the scripting result of the central management unit to regenerate a load to the server group.

In accordance with a third aspect of the present invention, there is provide a method of testing online performance on a client/server architecture, the client/server architecture including a client group and a server group connected to each other through a network, the method including: setting a capture-target protocol of packet information for communication between the client group and the server group; setting capture-target port and IP information of the packet information; capturing the packet information and storing the captured packet information; analyzing and editing the stored packet information; and generating a virtual client to regenerate a load to the server group, if said analyzing and editing the packet information is completed.

The present invention is characterized in that network packets are captured at an online game server for a test of performance and stability of the online game server. In this case, a load larger than real may be applied to a server application. In order to prevent application of the larger load, a module for packet capture may be provided separately from the server, or a packet capture method that does not produce an additional load may be provided.

The present invention is characterized in that validity of packet data as a load is determined by a packet analysis unit, and only packets used in a normal game play are used for a test of performance of the server.

The present invention is characterized in that a structure of reproducing or generating a large quantity of load is provided for the test of performance and stability of an online game server for multiple users. Therefore, a load generator is executed in multiple hosts for the performance and stability test.

The present invention is characterized in that a monitoring unit for confirming the state of the game server is provided to monitor the state of the game server in real time.

In accordance with the present invention, the invention can be applied to a test of performance and stability of online games in all genres, and can reduce costs and time for the test. In addition, since a virtual load corresponding to the game user for a test is collected by capturing communication packets at the game server end, the test can be rapidly carried out without a high degree of additional work. Furthermore, since an operation is simply performed, a test of system stability can be easily performed by a developer or a system engineer.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of an apparatus for testing online performance on client/server architecture in accordance with a first embodiment of the invention;

FIG. 2 is a block diagram showing the configuration of an apparatus for testing online performance on a client/server architecture in accordance with a second embodiment of the invention;

FIG. 3 is a flowchart illustrating an online performance test process on a client/server architecture in accordance with the second embodiment of the invention; and

FIGS. 4A and 4B are diagrams illustrating packet analysis, packet edition and scripting for load generation in accordance with the present invention.

### DETAILED DESCRIPTION OF THE EMBODIMENTS

Hereinafter, embodiments of the invention will now be described in detail with reference to the accompanying drawings which form a part hereof.

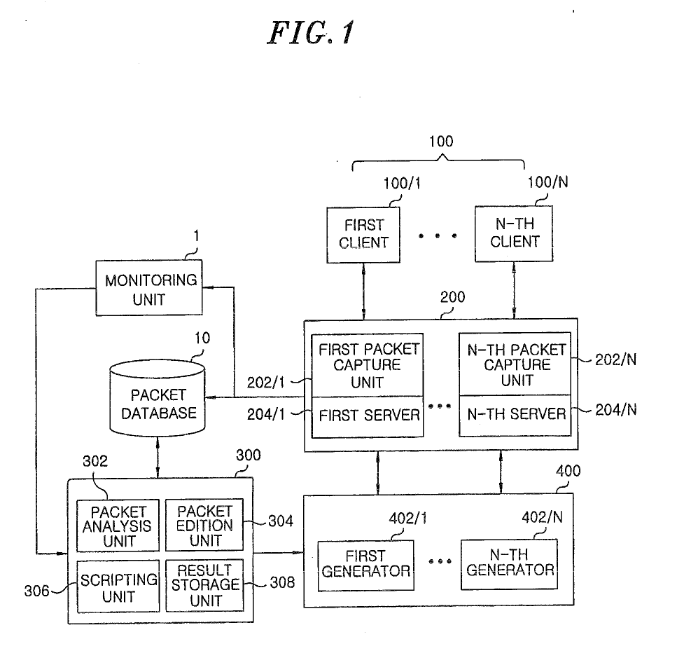

FIG. 1 is a block diagram showing the configuration of an apparatus for testing online performance on a client/server architecture in accordance with a first embodiment of the invention. The apparatus includes a client group 100, a server group 200, a central management unit 300, a load generation unit 400, a monitoring unit 1 and a packet database 10.

As shown in FIG. 1, the client group 100 is, for example, a game client group for an interactive application, and is connected to the server group 200 through a network (not shown) for example, Internet to use an online game service.

The server group 200 is, for example, a game server group for an interactive application, and provides the online game service to the client group 100 through the network.

The server group 200 includes a plurality of servers 204/1 to 204/N for online game services, and packet capture units 202/1 to 202/N provided to correspond to the servers 204/1 to 204/N. For example, a first server 204/1 has a first packet capture unit 202/1, and a second server 204/2 has a second packet capture unit 202/2.

An arbitrary packet capture unit, for example, the first packet capture unit 202/1 collects a communication process between an arbitrary client and a server, for example, between a first client 100/1 and the first server 204/1.

Specifically, the first packet capture unit 202/1 sets a target protocol for packet collection for example, TCP (Transmission Control Protocol) or UDP (User Datagram Protocol)), sets network information for example, IP address information and port information in accordance with the set target protocol, and collects packets to be transmitted and received between the first client 100/1 and the first server 204/1 by using a packet capture driver in accordance with the set network information to capture packet information.

The packet database 10 temporarily stores the captured packet information.

The monitoring unit 1 monitors the current state of the server group 200, for example, the number of clients to be connected to the server group 200, the network usage, the resource usage of each server in the server group 200, the response time and the like, and transmits the monitoring result to the central management unit 300 described below.

The central management unit 300 includes a packet analysis unit 302, a packet edition unit 304, a scripting unit 306 and a result storage unit 308. The central management unit 300 overall manages a test process of the apparatus for testing online performance on the client/server architecture.

The packet analysis unit 302 in the central management unit 300 reads out packet information stored in the packet database 10 and carries out a data validity check for the packet information. That is, the packet analysis unit 302 analyzes of which type the packet is, for example, whether the packet is a log-in packet for access to the first server 204/1, a mobile packet for position change or the like. Through such a validity check, insignificant packets are discarded and only packets for actual game progress are included in the analysis process. Here, during the analysis process of the packet analysis unit 302, tag information is set for packets collected from the client, for example, the first client 100/1. The tag information includes the unique ID of a packet list and packet information on whether the packet is a packet used in the log-in process or a packet used for world entrance.

The packet edition unit 304 edits internal data of the packets analyzed by the packet analysis unit 302. That is, when part of data of the captured packet is required to be substituted with a different value, for example, when ID or password edition is required, the packet edition unit 304 processes the corresponding packet.

The scripting unit 306 creates a scenario script for the online performance test on the client/server architecture in accordance with the edition result of the packet edition unit 304. For example, the scripting unit 306 executes a series of processes for a performance test to create the script by using conditional statements, looping statements, branching statements and the like on the basis of items to test, for example, by reproducing captured packet information as it is, or regenerating collected packets in quantity, increasing the number of users, and repeating the log-in test.

The result storage unit 308 stores the entire work process including the scenario script created by the scripting unit 306.

Further, the load generation unit 400 generates a load functioning as a client during the online performance test on the client/server architecture, i.e., a virtual client to connect the virtual client to the server group 200. The load generation unit 400 includes a plurality of generators 402/1 to 402/N. Each of the generators 402/1 to 402/N receives the scenario script stored in the result storage unit 308 of the central management unit 300, generates a virtual client in accordance with the received scenario script and applies the load to the server group 200. In this case, the load to be generated is limited by the performance of the host system, thus if multiple hosts are provided, a larger number of virtual clients may be generated.

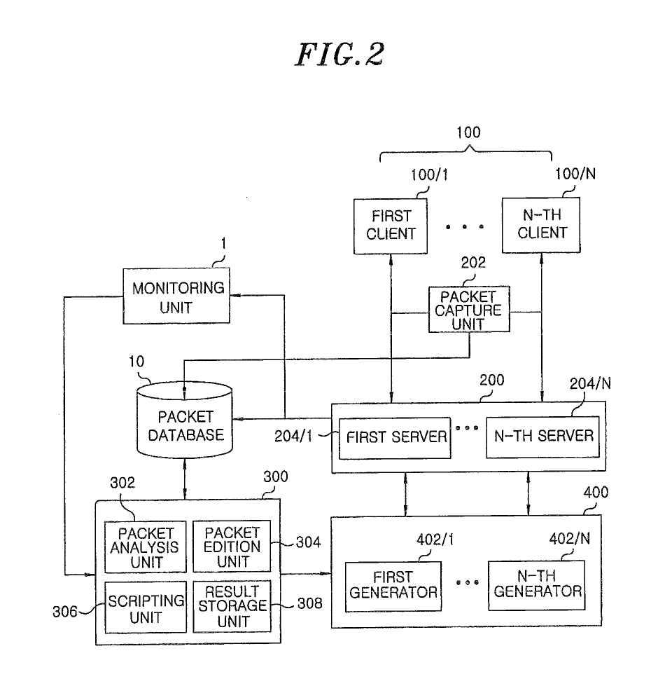

FIG. 2 is a block diagram showing the configuration of an apparatus for testing online performance on a client/server architecture in accordance with another embodiment of the invention. The apparatus includes a client group 100, a server group 200, a packet capture unit 202, a central management unit 300, a load generation unit 400, a monitoring unit 1 and a packet database 10.

The embodiment of FIG. 2 is different from the embodiment of FIG. 1 in that the packet capture unit 202 is provided in front of the server group 200, not being provided in each server of the server group 200. In this case, as compared with the embodiment of FIG. 1, the packet capture unit 202 is provided outside the server group 200, and thus the service load of the server group 200 is relatively reduced.

As shown in FIG. 2, the client group 100 is, for example, a game client group for an interactive application, and is connected to the server group 200 through a network (not shown) for example, Internet to use an online game service.

The server group 200 is, for example, a game server group for an interactive application, and provides an online game service to the client group 100 through the network. The server group 200 includes a plurality of servers 204/1 to 204/N for online game services.

The packet capture unit 202 is provided in front of the server group 200 to collect a communication process between an arbitrary client and a server, for example, the first client 100/1 and the first server 204/1.

Specifically, the packet capture unit 202 sets a target protocol for packet collection for example, TCP or UDP, set network information for example, IP address information and port information in accordance with the set target protocol, and collects packets to be transmitted and received between the first client 100/1 and the first server 204/1 by using a packet capture driver in accordance with the set network information to capture packet information.

The packet database 10 temporarily stores the captured packet information.

The monitoring unit 1 monitors the current state of the server group 200, for example, the number of clients connected to the server group 200, the network usage, the resource usage of each server in the server group 200, the response time, and the like, and transmits the monitoring result to the central management unit 300 described below.

The central management unit 300 includes a packet analysis unit 302, a packet edition unit 304, a scripting unit 306 and a result storage unit 308. The central management unit 300 overall manages a test process of the apparatus for testing online performance on the client/server architecture.

The packet analysis unit 302 in the central management unit 300 reads out packet information stored in the packet database 10 and carries out a data validity check for the packet information. That is, the packet analysis unit 302 analyzes of which type the packet is, for example, whether the packet is a log-in packet for access to the first server 204/1, a mobile packet for position change, or the like. Through such a validity check, insignificant packets are discarded and only packets for actual game progress are included in the analysis process. In this case, during the analysis process of the packet analysis unit 302, tag information is set for packets collected from the client, for example, the first client 100/1. The tag information includes the unique ID of a packet list, and packet information on whether the packet is a packet used in the log-in process or a packet used for world entrance.

The packet edition unit 304 edits internal data of the packets analyzed by the packet analysis unit 302. That is, when part of data of the captured packet is required to be substituted with a different value, for example, when ID or password is required to be edited, the packet edition unit 304 processes the corresponding packet.

The scripting unit 306 creates a scenario script for the online performance test on the client/server architecture in accordance with the edition result of the packet edition unit 304. For example, the scripting unit 306 executes a series of processes for a performance test to create the script by using conditional statements, looping statements, branching statements, and the like on the basis of items to test, for example, by reproducing captured packet information as it is, or regenerating collected packets in quantity, increasing the number of users and repeating the log-in test.

The result storage unit 308 stores the entire work process including the scenario script created by the scripting unit 306.

Further, the load generation unit 400 generates a load as a client during the online performance test on the client/server architecture, that is, a virtual client, and connects the virtual client to the server group 200. The load generation unit 400 includes a plurality of generators 402/1 to 402/N. Each of the generators 402/1 to 402/N receives the scenario script stored in the result storage unit 308 of the central management unit 300, generates a virtual client in accordance with the received scenario script, and applies the load to the server group 200. In this case, the load to be generated is limited by the performance of the host system, thus if multiple hosts are provided, a larger number of virtual clients may be generated.

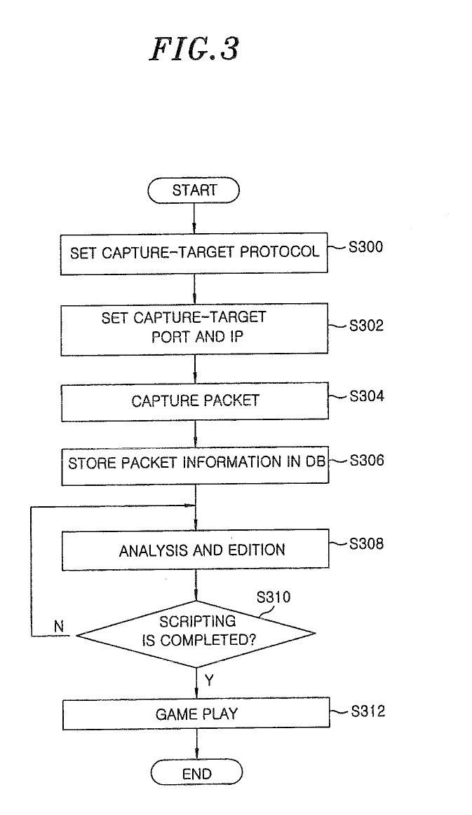

Hereinafter, a method of testing online performance on a client/server architecture in accordance with an embodiment of the invention by using the above-described configuration, specifically, a packet capture and load generation process, which sequentially shows a process for packet collection and generation for a performance test of an online game server will be described in detail with reference to a flowchart of FIG. 3.

Prior to the description of the embodiment, it is to be noted that, for salience of an online environment, to which an interactive application is applied during the online performance test on the client/server architecture and ease of understanding of the embodiment, the client group 100 is a game client group, and the server group 200 is a game server group.

The packet capture unit for the online performance test of this embodiment may be provided in an arbitrary service in the server group, as shown in FIG. 1, or may be provided in front of the server group, as shown in FIG. 2. In the description of the embodiment of FIG. 3, the packet capture unit 202 that is applied to the apparatus for testing online performance with a relatively small service load of the server group 200 is illustratively applied.

As shown in FIG. 3, first, the packet capture unit 202 provided in front of the server group 200 sets a capture-target protocol for packet collection in step S300. Since the client/server online environment mostly uses TCP and UDP from among various protocols, such as ICMP (Internet Control Message Protocol), IGMP (Internet Group Management Protocol), GGP (Gateway-to-Gateway Protocol), and the like, as the target protocol, TCP, UDP, or both of them may be set.

Next, the packet capture unit 202 sets capture-target port and IP in step S302. Packets other than packets to be transmitted from and received to the target client may be transmitted from and received to the server group 200, and thus the target port and IP are set to primarily filter these packets.

If the capture-target port and IP are set, the packet capture unit 202 collects packet information based on communication between the client group 100 and the server group 200 to start capturing in step S304.

The so-captured packet information is stored in the packet database 10 as original data in step S306.

The packet information stored in the packet database 10 is subject to a series of processes, such as a packet analysis process, a packet edition process, a scripting process, and the like, by the central management unit 300 in step S308.

The packet analysis process includes a process for reading out packet information stored in the packet database 10 and checking data validity of the packet information. For example, the packet analysis process analyzes of which type the packet is, for example, whether the packet is a log-in packet for access to the first server 204/1, a mobile packet for position change, or the like. Through such a validity check, insignificant packets are discarded and only packets for actual game progress are included in the analysis process. In this case, during the packet analysis process, tag information is set for packets collected from the client, for example, the first client 100/1. The tag information includes the unique ID of a packet list, and packet information on whether the packet is a packet used in the log-in process or a packet used for world entrance.

The packet edition process includes a process for editing internal data of each packet analyzed through the packet analysis process. That is, when part of data of the captured packet is required to be substituted with a different value, for example, when ID or password is required to be edited, the packet edition process includes a process in which the corresponding packet is processed.

The scripting process creates a scenario script for the online performance test on the client/server architecture in accordance with the edition result of the packet edition process. For example, the scripting process includes a series of processes for a performance test to create the script by using conditional statements, looping statements, branching statements, and the like on the basis of items to test, for example, by reproducing captured packet information as it is, or regenerating collected packets in quantity, increasing the number of users, and repeating the log-in test.

Thereafter, if the packet analysis process, the packet edition process, the scripting process, and the like are completed in step S310, the central management unit 300 stores the work result through the packet analysis process, the packet edition process, the scripting process and the like, for example, the scenario script, and transmits the work result to the load generation unit 400.

The load generation unit 400 generates a virtual client in accordance with the scenario corresponding to the transmitted work result, and regenerates a load in the server group 200 to construct an online service environment for online game play of the virtual client in step S312.

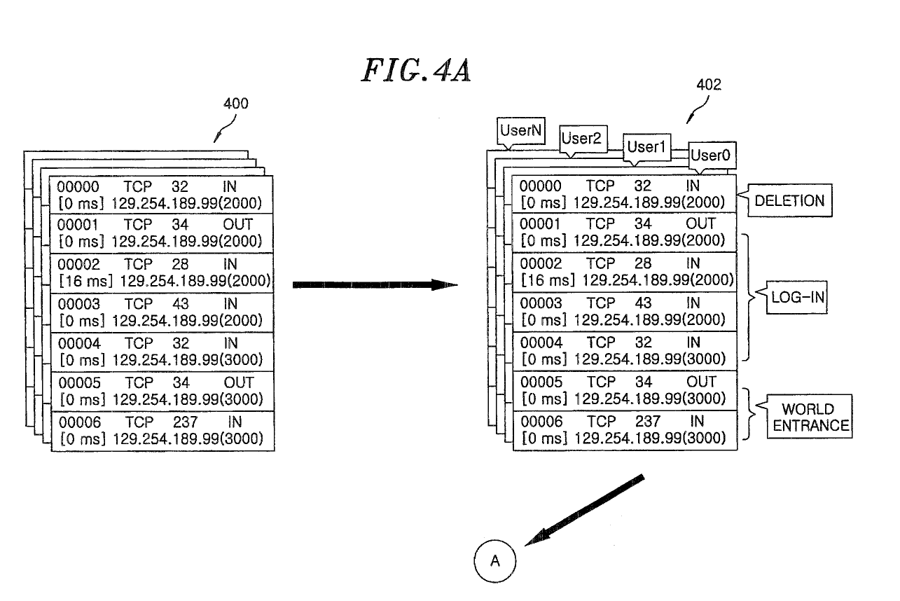

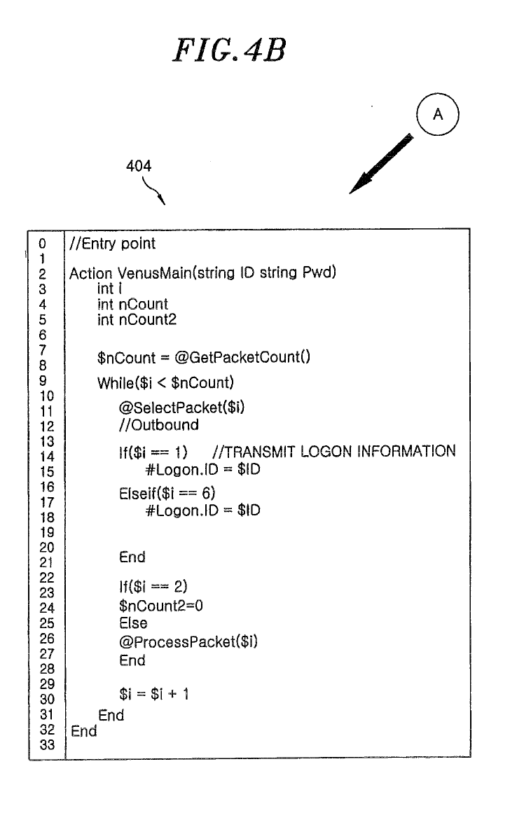

FIGS. 4A and 4B are diagrams illustrating packet analysis, packet edition and scripting for load generation.

As shown in FIG. 4A, the packets stored in the packet database 10 as the result of packet collection is a collection of packet lists, as represented by reference numeral 400. In the packet analysis unit 302, a unique ID may be given to such raw data, and an unnecessary portion may be deleted.

As represented by reference numeral 402, during the packet analysis process, a tag that is used to identify a packet for reuse, that is, whether a packet is a packet for log-in or a mobile packet is attached to a packet. After the packet analysis process ends, the packet edition unit 304 edits internal data of each packet. During the packet edition process, the structure of a portion of packet data that should be substituted is defined and named.

As shown in FIG. 4B, reference numeral 404 shows a scripting process for test scenario creation, in which the test scenario is created by using conditional statements, looping statements, and branching statements, for example, predefined packet information is substituted.

As described above, according to this embodiment, the technology for testing online performance on the client/server architecture that collects all communication packets between a plurality of clients and servers, captures packets of all the game clients at the server group, and reproduces or regenerates a large load, thereby collecting various behavioral patterns of the game users for a test of performance of the server.

While the invention has been shown and described with respect to the embodiment, it will be understood by those skilled in the art that various changes and modifications may be made without departing from the scope of the invention as defined in the following claims.

What is claimed is:

1. An apparatus for testing online performance on a client/server architecture, the apparatus comprising:
a client group connected to a server group through a network to use an online service;
a server group for providing the online service to the client group through the network and capturing packet information based on communication with the client group;
a central management unit for carrying out analysis, edition, and scripting for the captured packet information to overall manage an online performance test between the client group and the server group; and
a load generation unit for generating a virtual client in accordance with the scripting result of the central management unit to regenerate a load in the server group.

2. The apparatus of claim 1, wherein the server group includes a plurality of servers for online game services, wherein each server has a packet capture unit.

3. The apparatus of claim 2, wherein the packet capture unit sets a target protocol for packet collection, sets network information in accordance with the set target protocol, and collects packets to be transmitted and received between the client group and the server group to capture packet information.

4. The apparatus of claim 1, wherein the central management unit includes:
a packet analysis unit for carrying out a data validity check for the packet information,
a packet edition unit for editing internal data of each packet analyzed by the packet analysis unit,
a scripting unit for creating a scenario script for the online performance test between the client group and the server group in accordance with the edition result of the packet edition unit, and
a result storage unit for storing a work process including the scenario script created by the scripting unit.

5. An apparatus for testing online performance on a client/server architecture, the apparatus comprising:
a client group connected to a server group through a network to use an online service;
a server group for providing the online service to the client group through the network;
a packet capture unit for capturing packet information based on communication between the client group and the server group;
a central management unit for carrying out analysis, edition, and scripting for the captured packet information to overall manage an online performance test between the client group and the server group; and
a load generation unit for generating a virtual client in accordance with the scripting result of the central management unit to regenerate a load to the server group.

6. The apparatus of claim 5, wherein the packet capture unit sets a target protocol for packet collection, sets network information in accordance with the set target protocol, and collects packets to be transmitted and received between the client group and the server group to capture packet information.

7. The apparatus of claim 5, wherein the central management unit includes:
a packet analysis unit for carrying out a data validity check for the packet information;
a packet edition unit for editing internal data of each packet analyzed by the packet analysis unit;
a scripting unit for creating a scenario script for the online performance test between the client group and the server group in accordance with the edition result of the packet edition unit; and
a result storage unit for storing a work process including the scenario script created by the scripting unit.

8. The apparatus of claim 7, wherein the packet analysis unit sets tag information to each packet collected from the client group.

9. The apparatus of claim 7, wherein the scripting unit creates a script by using conditional statements, looping statements and branching statements in accordance with items to test.

10. A method of testing online performance on a client/server architecture, the architecture including a client group and a server group connected to each other through a network, the method comprising:
setting a capture-target protocol of packet information for communication between the client group and the server group;
setting capture-target port and IP information of the packet information;
capturing the packet information and storing the captured packet information;
analyzing and editing the stored packet information; and
generating a virtual client to regenerate a load to the server group, if said analyzing and editing the packet information is completed.
